(19) United States
(12) Patent Application Publication
(10) Pub. No.: US 2011/0226279 A1
(43) Pub. Date: Sep. 22, 2011

(54) Unified Floss and Guide Device for Persons Wearing Orthodontic Braces

(76) Inventor: Stephanie Lee Thorne, (US)

(21) Appl. No.: 12/728,209

(22) Filed: Mar. 20, 2010

(51) Int. Cl. A61C 15/04

(52) U.S. Cl. 132/323

(57) ABSTRACT

The present invention is a device and manufacturing method to be used by persons wearing orthodontic braces to simplify the task of flossing their teeth. The device consists of a convenient pre-cut length of dental floss with a first and second end, an elongated guide element fabricated from a semi-rigid material suitable for oral use and configured with an attachment aperture, an optional flex aperture, and optional curvature, and further consisting of pre-attachment of the floss first end to the guide element leaving the second end of the floss unencumbered. Preferentially, the means of pre-attachment is accomplished with a friction knot formed by first inserting a looped length of floss through the guide attachment aperture then folding the tip of the guide element through the loop and retracting the slack in the floss until it gathers tightly and securely around the trailing end of the guide element. This attachment method advantageously can be accomplished without employing the time consuming method of tying a conventional knot. The invention further includes sanitary enclosure in an envelope, preferentially the size of a credit card, for convenient transport in a wallet or purse.

### FIELD OF THE INVENTION

The present invention relates generally to the fields of dentistry and orthodontics. In particular, this invention relates to devices used for flossing teeth that have been affixed with orthodontic braces.

### BACKGROUND OF THE INVENTION

It is generally accepted that the daily flossing of one's teeth is a valuable component of good dental hygiene. However, for many individuals who are undergoing corrective orthodontic treatment that involves the affixation of braces onto their teeth, the flossing procedure is cumbersome. This is because the brackets and wires affixed to the teeth obstruct the manipulation of the floss into the space between two teeth. For a person wearing braces, one end of the floss must first be directed into and through the small gaps between the wires spanning adjacent teeth before access to the space can be gained. Such difficulty can make a flossing session excessively time consuming and frustrating. Because a majority of brace wearers are children who are often impatient or tired, this difficulty often causes them to skip cleaning some teeth or neglect the session altogether. Accordingly, there is a great need for a flossing device that will simplify and shorten this process.

There are numerous prior art devices that have made it their object to make the flossing process easier for brace wearers. As far back as 1952, when U.S. Pat. No. 2,612,177 was issued to Footer, it was recognized that the tip of a piece of floss was too limp to withstand repeated insertion into the tight gaps between teeth. Footer introduced a flossing device wherein one end of the dental floss was impregnated with a thermoplastic material to form a tip capable of being directly inserted into occlusal spaces. An advantageous variation of this idea was taught in U.S. Pat. No. 5,392,794 issued in 1995 to Striebel, wherein he devised a longer tip integrally bonded with the floss and including a curvature. Striebel also began to understand the need to introduce a modification that would shorten the flossing session by introducing ready-to-use floss sections interconnected in a chain like fashion that could be unwound from a dispenser and snapped off.

The problem with prior art devices like Footer's and Striebel's is that dental floss is made from a very thin thread-like material which typically has a wax coating to facilitate the sliding of the floss through the tight gaps between teeth. “Impregnating” the floss with a thermoplastic material as proposed by Footer, or “integrally bonding” the floss with a “low-friction plastic” as proposed by Striebel is not easily accomplished in a manner that can withstand the tensile forces usually applied during the flossing process. Further, “impregnating” or “bonding” must be accomplished while maintaining the strict size limit required to allow passage through the small gaps formed by the brace brackets and wires.

Another strategy found in the prior art that looks to streamline the flossing process for brace wearers can be found in U.S. Pat. Nos. 3,929,144 and 4,011,658 issued to Tarrson et al in 1975 and 1977 respectively, and U.S. Pat. No. 4,133,339 issued to Naslund in 1979. In these patents, a modified needle has been provided for guiding the floss through tight brace spaces. To begin a flossing session, the user must first unroll dental floss from a floss dispenser, cut the floss to a usable length, and then thread the end of the floss through the eye of the needle. Only then is the flossing device ready to be used. But after using the device to manipulate the floss through the brace area, the needle is separated from the floss. Accordingly, the floss must be threaded back through the needle before it can be used for the next gap and each subsequent gap. Using the devices of Tarrson and Naslund and the like, the brace wearer must thread the needle roughly twenty-eight times per flossing session. Thus, while such devices are efficient in assisting the user to steer the floss through the braces, they have not significantly reduced the time needed to complete a flossing session. Further drawbacks to such devices is that after the floss has been directed through the braces, the needle is withdrawn from the floss and typically placed on a counter so the user's hands are free to manipulate the floss. This creates two problems. First, the needle is occasionally dropped onto the floor, or into the sink making it time consuming to retrieve for the next threading or even forcing the user to use a second needle. Secondly, by setting down the needle onto a counter—one that may or may not be clean and sterile—the needle may collect germs or bacteria that will then be directed into the user's mouth. Such a concern is particularly relevant if the user attempts to floss with these types of devices in a public facility where sanitation is less controlled.

A prior art attempt to eliminate the problems associated with the needle being unattached to the floss was described in U.S. Pat. No. 4,064,883 issued to Oldham in 1977 and then assigned to Johnson and Johnson—a major manufacturer of dental floss. Oldham's invention is a threading needle that includes a slot to “lock the floss in place and prevent slippage of the floss during use.” The problem with Oldham's device is that the short semi-rigid film elements located at the end of eyelets of his device (referenced as numeral 22 in his drawings) quite simply are not strong enough to secure the floss for the length of a flossing session. While it may temporarily bind the floss, if the user pulls on the threader with significant tension, the floss pulls free of the locking means. And because the threader is fabricated from semi-rigid material, the locking ability of Oldham's device gets progressively weaker with each subsequent locking attempt. A further problem that arises with Oldham's device is that when the floss is set into the locking slot, it spreads the film surfaces creating a gap that may catch on the brace wires—possibly becoming entangled and frustrating the user.

A final relevant prior art strategy for simplifying the flossing process addresses this last concern and can be found in U.S. Pat. No. 5,890,500 issued to Mabon et al in 1999. In this invention, the floss is directed first through a tubular spaghetti-sized device that can be directed through the brace gaps and then slid along the floss to a position that can remain with the floss, but not obstruct the flossing of the teeth. The advantages of Mabon's device is that it does not have to be “threaded” twenty-eight times per flossing session, nor does it have to be repeatedly set on the counter and thus is not subject to collecting germs. Unfortunately, for Mabon's tubular guide element to be directed through the narrow gaps typical of braces, the diameter must be very small, and steering the end of the floss through the device is difficult. Mabon recognized this and provided an optional flared end to assist the threading process, but the geometry of the brace gap restricts the size of the flared end resulting in a device that is still difficult to thread.

Thus, despite over fifty years of prior art attempts by both individual inventors and major companies to devise an efficient flossing device for brace wearers, there is still a need for an improved device that will shorten the flossing session.

### BRIEF SUMMARY OF THE INVENTION

The present invention is a device and manufacturing method to be used by persons wearing orthodontic braces to simplify the task of flossing their teeth. The device consists of a convenient pre-cut length of dental floss with a first and second end, an elongated guide element fabricated from a semi-rigid material suitable for oral use and configured with an attachment aperture, an optional flex aperture, and optional curvature, and further consisting of pre-attachment of the floss first end to the guide element leaving the second end of the floss unencumbered. Preferentially, the means of pre-attachment is accomplished with a friction knot formed by first inserting a looped length of floss through the guide attachment aperture then folding the tip of the guide element through the loop and retracting the slack in the floss until it gathers tightly and securely around the trailing end of the guide element. This attachment method advantageously can be accomplished without employing the time consuming method of tying a conventional knot. The invention further includes sanitary enclosure in an envelope, preferentially the size of a credit card, for convenient transport in a wallet or purse.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### LIST OF FIGURES

FIG. 1 is an elevational view of an exemplary embodiment of the invention.

FIG. 2 is an elevational view of another exemplary embodiment of the invention.

FIG. 3 is a side elevational view of the same embodiment of the invention shown in FIG. 2.

FIG. 4A & FIG. 4B are schematic views of an exemplary embodiment of this invention being manipulated by the user. And FIG. 4B is a view from inside the mouth.

FIGS. 5A-5D are schematic perspective views illustrating four steps of one assembly method for an exemplary embodiment of this invention.

FIGS. 6A-6D are schematic perspective views illustrating four steps of another assembly method for an exemplary embodiment of this invention.

FIG. 7 is an elevational view of an exemplary embodiment of this invention including a method of packaging.

LIST OF REFERENCED NUMERALS & LETTERS

| | |
|---|---|
| 10 | unified floss and guide device |
| 20 | pre-cut length of dental floss |
| 22 | attachment end |
| 24 | unencumbered end |
| 26 | friction knot |
| 28 | loop |
| 29 | twist |
| 30 | guide |
| 32 | guide tip |
| 34 | attachment aperture |
| 36 | flex aperture |
| 40 | hand |
| 42 | thumb |
| 44 | index finger |
| 50 | teeth space |
| 52 | gums |
| 54 | tooth |
| 56 | brackets |
| 58 | wires |
| 60 | sanitary envelope |
| A | loop axis |
| W | guide width |
| X | guide thickness |
| Y | bracket separation |

### DETAILED DESCRIPTION OF THE INVENTION

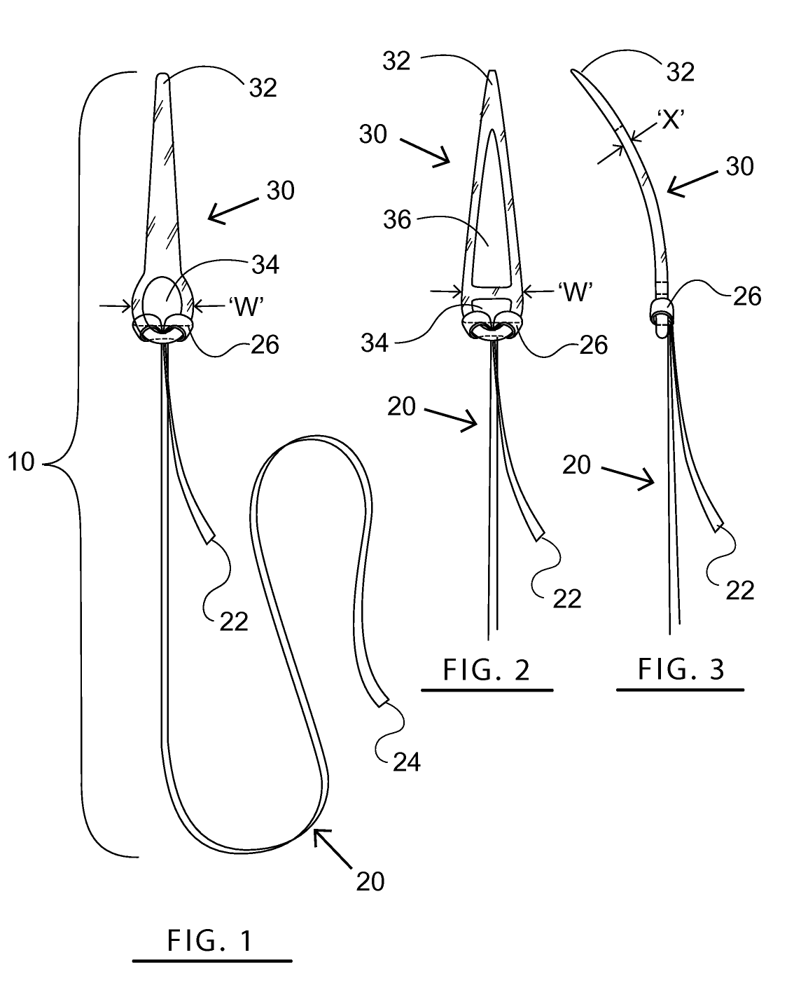

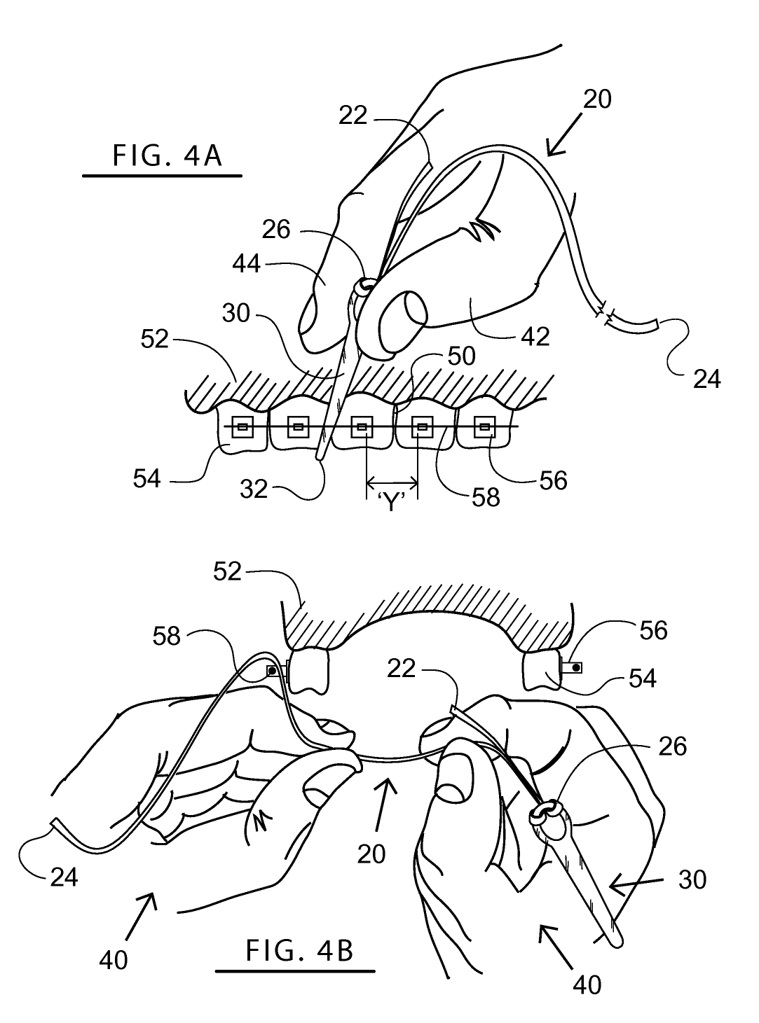

The present invention is a device and manufacturing method for a flossing tool to be used by persons wearing orthodontic braces. The unique improvements over prior art devices can be learned first with reference to FIGS. 1, 2, and 3. Unified floss and guide device 10 includes a pre-cut convenient length of dental floss 20, pre-attached to elongated guide 30. Floss 20, preferentially 10″ to 16″ in length, has an unencumbered end 24, an attachment end 22, and is typically fabricated from a known common ribbon-style type of dental floss that is pre-waxed. Guide 30 includes a tapered guide tip 32, an attachment aperture 34, and, optionally, a flex aperture 36 and is fabricated from a semi-rigid material suitable for oral use and optionally from plastic materials such as nylon, polyolefilm, acetal, and the like, which may be injection molded to produce a smooth, clean unitary structure. Guide 30 is normally of length between 1″ to 2″, and optionally includes a curvature over a substantial length of its body as shown in FIG. 3. Such curvature is normally 1.25″ to 2″ in radius, and can be in the plane defined by the width and length of the guide, or in the plane perpendicular to that, or a plane that is a partial combination of the two. Important to the geometry of guide 30 is width dimension “W,” which should be kept as small as possible and, preferentially, no wider than 0.125″ to facilitate the guidance through the narrow gap width “Y” typically found between brace brackets 56, shown in FIGS. 4A and 4B. Guide 30 should also be fabricated as thinly as possible—with a thickness ‘X’ normally of order 0.01″ to 0.03″ inches to facilitate passage through the gap between brace wires 58 and teeth 54 which is of order 0.05″ or so. Optional flex aperture 36 allows compression in the width of guide 30.

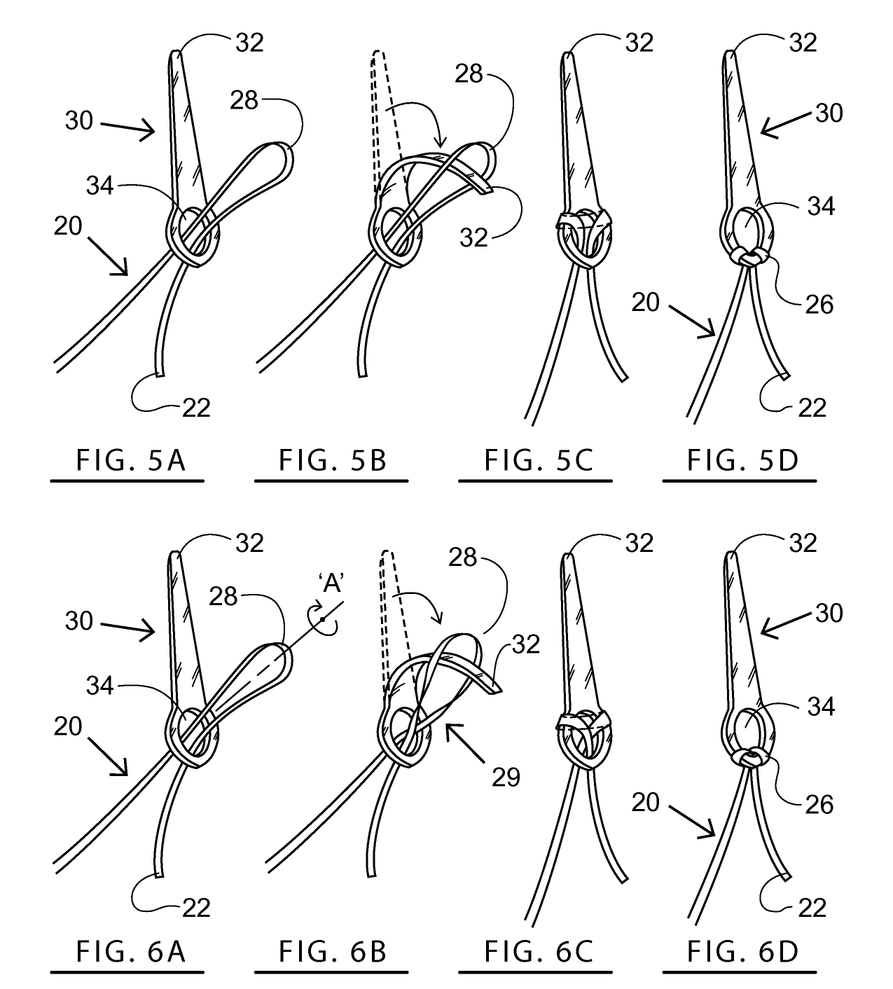

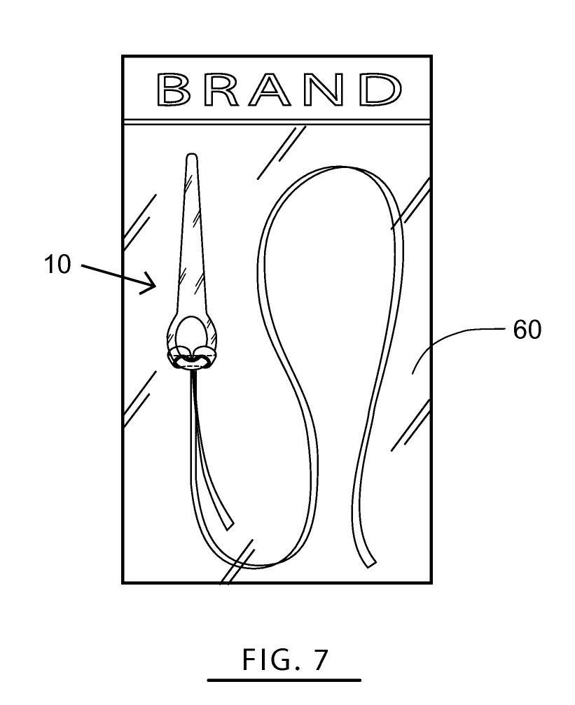

Pre-attachment of floss 20 to guide 30 can be accomplished utilizing attachment aperture 34 in numerous known ways such as by tying attachment end 22 of floss 20 with a common knot. Alternatively, a length of floss 20 may be integrally molded with guide 30 during the manufacturing process. However, this invention includes an optional novel means of attachment that substantially reduces the time and complexity of the manufacturing process. With reference to FIGS. 5A-5D, a length of loop is formed near attachment end 22, typically 1″ to 1.5″ long, and defining an axis “A” then inserted through attachment aperture 34. Guide tip 32 is then flexed down and pushed through loop 28, straightened, and finally pulled in a direction opposite to the combined pull on floss 20 and attachment end 22 to remove the slack and until the floss is gathered tightly around the end of aperture 34 to form friction knot 26. When proper securing tension is applied, friction knot 26 tightens and distorts floss 20 with the preferred wax coating to bind it together and make it sufficiently resistant to removal. Optionally, with reference to FIGS. 6A-6D, loop 28 includes a twist 29 formed by rotating loop 28 at least 180 degrees about loop axis “A” prior to the step where guide tip 32 is pushed through loop 28.

FIGS. 4A & 4B illustrate how the invention is normally used during a typical flossing session. Guide 30, already pre-attached to pre-cut floss 20, is held in the user's hand 40 pinched between thumb 42 and index finger 44. Guide tip 32 is directed into and through the gap between teeth 54 and brace wires 58. Guide width ‘W’ is preferably narrower than bracket separation ‘Y’, though if guide 30 includes flex aperture 36 it may still be made to pass through the separation even if it is slightly wider than ‘Y’ by compressing in width. Once guide 30 has passed through the brace region, floss 20 is free to be directed by the user into the accessible teeth space 50. After those teeth are flossed, unified floss and guide device 10 can be pulled out of the user's mouth by continuing to pull on guide 30 until unencumbered end 24 also passes through the brace gap. Note that guide 30 remains attached to floss 20 throughout this process and thus is ready to be directed into the next teeth space without needing to be re-threaded as required by prior art devices. Note too that guide 30 does not have to be set down onto a counter or otherwise kept track of for it is secured to floss 20 for the duration of the flossing session.

FIG. 7 shows an embodiment of the invention including enclosure in sanitary envelope 60. Typically, one or a small plurality of unified floss and guide devices 10 are enclosed in sanitary envelope 60. This embodiment maintains the device in a sanitary condition until needed by the user and allows for convenient transport and eliminates the prior art necessity to carry separately a floss dispenser and a container of threading needles. Preferably, envelope 60 is of dimensions substantially similar to the dimensions of a credit card (3.375″ in width by 2.125″ in height) permitting the device to be carried conveniently in a user's purse, wallet, or the like.

Certain embodiments of the invention may include none, some, or all of the above technical advantages. One or more other technical advantages may be readily apparent to one skilled in the art from the figures, descriptions, and claims included herein.

What is claimed is:

1. A unified guide and flossing device, comprising:
a convenient pre-cut length of dental floss having first and second ends;
an elongated guide element fabricated from a semi-rigid material suitable for oral use and sized to permit passage through the gaps formed by the brackets and wires of orthodontic braces, with said guide element possessing an attachment aperture and a pre-attachment to said first end of said length of dental floss; and
an unencumbered said second end of said length of dental floss.

2. The unified guide and flossing device of claim 1, wherein said guide element includes a curvature over a substantial portion of its elongation.

3. The unified guide and flossing device of claim 1, wherein said guide element includes a second aperture, distinct from said attachment aperture, that allows the width of said guide element to compress when the user directs it through the gaps formed by the brackets and wires of orthodontic braces.

4. The unified guide and flossing device of claim 1, wherein said pre-attachment of said guide element to said pre-cut length of dental floss is by tying means.

5. The unified guide and flossing device of claim 1, wherein said pre-attachment of said guide element to said pre-cut length of dental floss is by means of a friction knot; said friction knot formed by first forming a loop at said first end of said pre-cut length of dental floss, then inserting said loop through said attachment aperture and directing said loop around one end of said guide element, then tightening the slack in said pre-cut length of dental floss such that it gathers tightly and securely around a section of said guide element that forms said attachment aperture.

6. The unified guide and flossing device of claim 1, wherein said pre-attachment of said guide element to said pre-cut length of dental floss is by means of a twisted friction knot; said twisted friction knot formed by first forming a loop at said first end of said pre-cut length of dental floss, said loop forming a linear axis substantially parallel with the line of said pre-cut length of dental floss not included in said loop, then inserting said loop through said attachment aperture, then forming a twist in said loop by rotating said loop a minimum of 180 degree about said linear axis of said pre-cut length of dental floss and directing said loop around one end of said guide element, then tightening the slack in said pre-cut length of dental floss such that it gathers tightly and securely around a section of said guide element that forms said attachment aperture.

7. The unified guide and flossing device of claim 1, wherein said pre-attachment of said guide element to said pre-cut length of dental floss is by integrally molding a portion of said pre-cut length of dental floss with said guide element during the manufacturing process of said element.

8. The unified guide and flossing device of claim 1, further including sanitary enclosure in a sealable envelope of dimensions substantially similar to 3.375 inches in width by 2.125 inches in height, said dimensions permitting said unified guide and flossing device enclosed in said envelope to be carried by the user in a typical credit-card wallet slot.
